(19) United States
(12) Patent Application Publication
(10) Pub. No.: US 2012/0221408 A1
(43) Pub. Date: Aug. 30, 2012

(54) METHOD AND SYSTEM FOR INFORMED MEDIA PLANNING

(75) Inventor: Joseph T. Pych, Hanover, NH (US)

(73) Assignee: NEXTMARK, INC., Hanover, NH (US)

(21) Appl. No.: 13/305,928

(22) Filed: Nov. 29, 2011

Related U.S. Application Data
(60) Provisional application No. 61/446,657, filed on Feb. 25, 2011.

(51) Int. Cl. G06Q 30/02

(52) U.S. Cl. 705/14.43; 705/14.49; 705/14.48; 705/14.61; 705/14.41

(57) ABSTRACT

A method and system for storing ad campaign information and allowing ad buyers and ad sellers access to that information the method performed in a computer system having one or more processors executing a unique set of instructions stored in system memory, the method including providing an ad buyer interface to allow an ad buyer to enter ad campaign information and providing an ad seller interface to allow an ad seller to view ad campaign information and to submit a proposal to participate in an ad campaign.

### RELATED APPLICATIONS

This application has the same inventor as, and claims the benefit of, U.S. Provisional Application No. 61,446,657, entitled, “METHOD AND SYSTEM FOR INFORMED MEDIA PLANNING,” and filed Feb. 25, 2011, the contents of which are hereby incorporated by reference in their entirety.

### BACKGROUND

“Half the money I spend on advertising is wasted; the trouble is, I don't know which half,” John Wannamaker, merchant and advertising pioneer.

The advertising profession has made significant progress since the early twentieth century, when Mr. Wannamaker so eloquently expressed his frustration with the state of the advertising art. Yet, advertising messages still miss their intended target all too often. Advertising campaigns are typically conducted by advertising buyers and sellers (“ad buyers” and “ad sellers” hereinafter) working together to match advertising for a particular product or service to an appropriate media outlet. An ad buyer, working on behalf of one or more clients (a merchant such as Mr. Wannamaker, for example) attempts to place advertisements related to one or more media campaigns in media (radio, television, print, or digital media, for example) in a manner that is both effective and efficient. An ad seller works with an ad buyer to match his available advertising opportunities to a buyer's needs.

One problem associated with the advertising process is that there is a significant gap, a disconnect, between the worlds of ad buyers and ad sellers. In Mr. Wannamaker's era, advertising was substantially limited to print advertising in the form of handbills, ads in newspapers, or ads in magazines. There were very few, broadly targeted, advertising opportunities, and a merchant (or his ad buyer) would almost certainly be aware of all those opportunities and be able to identify the ad sellers associated with those opportunities. Since that time, new media and, along with the new media, new advertising opportunities, have emerged. Radio, television, and, particularly, digital media have created an explosion of opportunities to advertise and to thereby reach potential customers. With so many ad buyers representing so many products, services, and companies, and so many ad sellers representing so many media outlets, it can be extremely difficult for ad buyers and sellers to get together on mutually advantageous projects. An ad buyer may be aware of some media outlets that might be appropriate for some of the goods or services they want to promote. Ad buyers may be completely unaware of media opportunities. Ad sellers may be completely unaware of ad campaigns. A system and method that promotes effective and efficient use of advertising resources would therefore be highly desirable.

### SUMMARY

A system and method in accordance with the principles of inventive concepts establishes and maintains a database of advertising campaigns. Ad buyers and ad sellers may be provided with controlled access to the database and may thereby become aware of potential collaboration. With access to an ad campaign database, an ad buyer may become aware of media outlet(s) and associated ad seller(s) that may be suitable for use with an ad campaign, and an ad seller may become aware of campaigns for which media outlets he or an associate represents would be suitable.

In exemplary embodiments, such a system and method may perform a matching process whereby one or more characteristics of ad campaign(s) are compared to characteristics of ad sellers, or the media outlet they represent, to determine which ad sellers, or media outlet, are appropriate for an ad campaign, for example.

In another aspect of a system and method in accordance with the principles of inventive concepts, a communications channel may be provided to allow communications between an ad buyer and an ad seller and between a system component, such as a matching component, and an ad seller or ad buyer. A communications channel between a matching component, for example, may be used by the system to alert an ad seller to a campaign that the system has determined to be suitable for the ad seller and/or to alert an ad buyer to the same. A communications channel may also be established between ad sellers and ad buyers, particularly after a match between an ad buyer's campaign and an ad seller's media outlet has been made, for example.

In another aspect of a system and method in accordance with the principles of inventive concepts, a system may provide an ad buyer interface to the ad campaign database. The ad buyer interface may permit an ad buyer to enter into a database information related to an ad campaign that the buyer is creating, for example. Additionally, the ad buyer interface may allow an ad buyer to monitor and control existing campaigns.

In another aspect of a system and method in accordance with the principles of inventive concepts, a system may provide an ad seller interface that allows an ad seller to enter into a database information related to the media opportunities he offers. Such media opportunities information may be used, for example, by the system in order to match an ad campaign to an ad seller. The ad seller interface may allow an ad seller to browse the database to determine whether there are active ad campaigns that he may wish to submit proposals for, for example. A system in accordance with the principles of inventive concepts may, after determining that an ad seller is a match for a particular ad campaign, alert the ad seller through the ad seller interface, for example. An ad seller may respond to such an alert through the ad seller interface by submitting a proposal to an ad buyer associated with the “matched” ad campaign.

A system and method in accordance with the principles of inventive concepts may include a computer system having one or more processors executing a set of instructions to generate an ad campaign database, provide an ad buyer interface to the ad campaign database, and provide an ad seller interface to the ad campaign database.

In another aspect in accordance with principles of inventive concepts, a system and method may accept ad campaign information through an ad buyer interface.

In another aspect in accordance with principles of inventive concepts, a system and method may store ad campaign information that includes indicia of the ad campaign's targeted media type.

In another aspect in accordance with principles of inventive concepts, a system and method may store ad campaign information that includes indicia of the ad campaign's targeted budget.

In another aspect in accordance with principles of inventive concepts, a system and method may store ad campaign information that includes indicia of the ad campaign's targeted media type.

In another aspect in accordance with principles of inventive concepts, a system and method may store ad campaign information that includes indicia of the ad campaign's calendar schedule.

In another aspect in accordance with principles of inventive concepts, a system and method may store ad campaign information that includes indicia of the ad campaign's content.

In another aspect in accordance with principles of inventive concepts, a system and method may store ad campaign information that includes matching information.

In another aspect in accordance with principles of inventive concepts, a system and method may accept media information through an ad seller interface.

In another aspect in accordance with principles of inventive concepts, a system and method may accept media information through an ad seller interface that includes a measure of media available for advertising.

In another aspect in accordance with principles of inventive concepts, a system and method may accept media information through an ad seller interface that includes indicia of content type.

In another aspect in accordance with principles of inventive concepts, a system and method may accept media information through an ad seller interface that includes matching information.

In another aspect in accordance with principles of inventive concepts, a system and method may accept ad campaign information through an ad buyer's interface, the ad campaign information including matching information; accept ad media information through an ad seller's interface, the ad media information including matching information; and compare the ad campaign matching information with the ad media matching information to determine whether the ad media is appropriate for an ad campaign.

In another aspect in accordance with principles of inventive concepts, a system and method may associate an ad seller with ad media information and alert an associated ad seller if ad media is determined to be appropriate for an ad campaign.

In another aspect in accordance with principles of inventive concepts, a system and method may accept proposal input from an ad seller through an ad seller interface and provide proposal input to an ad buyer associated with an ad campaign.

In another aspect in accordance with principles of inventive concepts, a system and method may accept response input from an ad buyer through an ad buyer interface and store response input.

In another aspect in accordance with principles of inventive concepts, a system and method may establish a communications channel between an ad buyer and an ad seller.

In another aspect in accordance with principles of inventive concepts, a system and method may update ad campaign database to reflect communications between an ad buyer and an ad seller.

### BRIEF DESCRIPTION OF THE DRAWINGS

The foregoing and other objects, features and advantages of embodiments of the present inventive concepts will be apparent from the more particular description of preferred embodiments, as illustrated in the accompanying drawings in which like reference characters refer to the same elements throughout the different views. The drawings are not necessarily to scale, emphasis instead being placed upon illustrating the principles of the preferred embodiments.

FIG. 1 is an architectural block diagram of a media planning system in accordance with embodiments of the present inventive concepts.

FIG. 2 is a flow chart that provides an overview of a media planning method in accordance with embodiments of the present inventive concepts.

FIG. 3A through FIG. 3P are screenshots illustrating exemplary interactions with an ad management system in accordance with the principles of the inventive concepts.

FIG. 4 is a block diagram of a computer system which may operate as a host for an ad campaign management system in accordance with the principles of the inventive concepts.

### DETAILED DESCRIPTION OF EXEMPLARY EMBODIMENTS

The terminology used herein is for the purpose of describing particular embodiments and is not intended to be limiting of the inventive concepts. As used herein, the singular forms “a,” “an” and “the” are intended to include the plural forms as well, unless the context clearly indicates otherwise. It will be further understood that the teens “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

It will be understood that, although the terms first, second, third etc. may be used herein to describe various limitations, elements, components, regions, layers and/or sections, these limitations, elements, components, regions, layers and/or sections should not be limited by these terms. These terms are only used to distinguish one limitation, element, component, region, layer or section from another limitation, element, component, region, layer or section. Thus, a first limitation, element, component, region, layer or section discussed below could be termed a second limitation, element, component, region, layer or section without departing from the teachings of the present application.

It will be further understood that when an element is referred to as being “on” or “connected” or “coupled” to another element, it can be directly on or above, or connected or coupled to, the other element or intervening elements can be present. In contrast, when an element is referred to as being “directly on” or “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.). When an element is referred to herein as being “over” another element, it can be over or under the other element, and either directly coupled to the other element, or intervening elements may be present, or the elements may be spaced apart by a void or gap.

Although claimed subject matter will be described in terms of certain embodiments, other embodiments, including embodiments that do not provide all of the benefits and features set forth herein, are also within the scope of this invention. Various structural, logical, and process step changes may be made without departing from the spirit or scope of the invention. Flow charts may include steps that may be deleted or otherwise modified and the sequence set forth within a particular flow chart may be modified while keeping within the scope of the invention. Accordingly, the scope of the invention is defined only by reference to the appended claims.

By “advertising campaign,” is meant an advertising project directed to a specific product or service, or group of products and/or services. Such products and services may include for-profit and not-for-profit products and services, including political campaigns and not-for profit requests for donations, for example. Such a project may have a budget, a “run time,” a targeted media type, or mix of media types, and capacity (e.g., thirty seconds on the radio, so many column inches in a magazine, a pixel array-size for a web-site ad, etc.) requirements for each media type.

In the present specification, the term “user” is interchangeable with the terms “web site visitor,” “end-user,” “publisher,” “content provider,” “administrator,” “system administrator,” “ad seller,” “ad buyer,” “media planner,” “media buyer,”and the like, and refers to an individual, or a group of individuals, for example. An ad seller may be anyone involved in the business of selling advertising “space” (i.e., a quantity of media for advertising), whether in print, electronic, digital, social or other media. An ad seller may represent one or more media outlets and the media outlets may be any one or any combination of media “types” or “channels.” An ad buyer may represent one or more entities, such as a goods- or service-provider, in purchasing advertising space in order to advertise the goods or services.

The term “ad space” may be used herein to describe a quantity of advertising media. Although derived from print media, in which the actual advertising quantity may be measured by the area, or space, an ad occupies, for example in a magazine, newspaper, or flier, the term may be applied to other, non-print advertising. Consequently, “ad space” in television or radio advertising may refer to the calendar schedule of an ad; in digital media it may refer to the number of impressions (that is, number of viewings) it receives; and, for mailing lists, the number of entries on a list, for example.

As used herein, the “type” of media generally refers to the technology employed by the media: print, television, radio, digital, social media, etc. The term media “channel” may also be used herein in reference to the type of media being referred to. The content of the media, or editorial content, as used herein, refers to the topical aspect of a given ad campaign or media outlet. For example, a fishing magazine would be said to contain fishing content, an ad campaign related to the New England Patriots would be said to have football content, etc. The term “category” may also be used herein to refer to the content of an ad campaign or a media outlet and, in exemplary embodiments, a system and method in accordance with the principles of the inventive concepts may employ Interactive Advertising Bureau (IAB) standard categories (also referred to herein as content categories) to delineate the types, or categories, of content associated with an ad campaign and/or media outlet.

A system and method in accordance with the principles of inventive concepts establishes and maintains a database of advertising campaigns. Ad buyers and sellers may be provided with controlled access to the database. Such a system and method allow ad buyers to reach a multitude of ad sellers who may represent media outlets that are appropriate for the ad buyer's advertising campaign and to make them aware of their campaign and the potential for selling their client(s)' media space to the ad buyer. Such a system and method may allow ad buyers to contact ad sellers representing media that is appropriate to their campaign that they otherwise may not have been aware of. It also allows ad sellers to become aware of ad campaigns that they otherwise may not have been aware of and to contact the associated ad buyers in order to place their media with the ad buyer.

In exemplary embodiments a system and method in accordance with inventive concepts maintain data structures related to contact information for ad buyers and ad sellers, for content types of media outlets, for content types of ad campaigns, for associating ad campaigns to ad buyers, for associating media outlets with ad sellers, for associating ad buyer ad campaign media types with ad seller media outlet types, for example. Information related to an ad campaign, such as media type, campaign dates, content category, budget, and ad buyer comments may be stored within the database and updated as the ad campaign progresses to reflect advertising purchases. Such information, also referred to herein as indicia, may be employed, not just to track the progress of an ad campaign, but also to match an ad seller to a particular campaign (e.g., an ad campaign for dog food may be matched to an ad seller representing a television program about dog training). Once a match is found, the ad buyer may be alerted to let them know of the ad seller and associated media that may be appropriate for their campaign, and an ad seller who has been matched to the campaign may also be alerted, in order to allow the ad seller to submit a proposal for selling ad space with the media entity they represent.

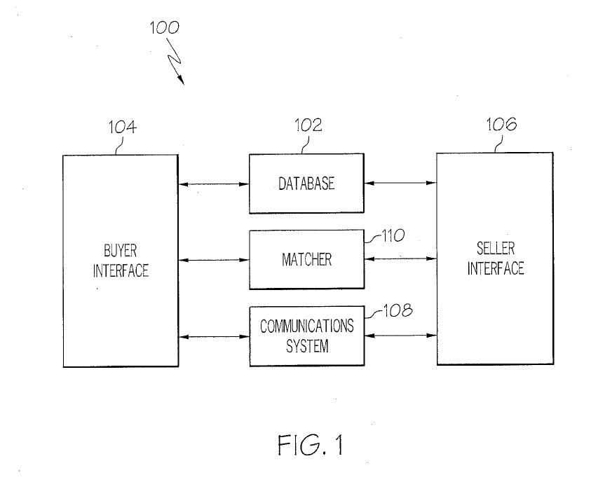

An exemplary embodiment of a media planning system 100 in accordance with the principles of the present inventive concepts is portrayed in the architectural block diagram of FIG. 1. In this exemplary embodiment, the system 100 includes a media planning database 102, an ad buyer interface 104, an ad seller interface 106, a communications system 108, and a media-matching system 110.

Media planning database 102 may be generated, for example, by an operator of a media planning system 100 who gathers information related to ad campaigns from one or more associated ad buyers. In addition to relying upon ad campaign managers to enter information related to ad campaigns, an operator of a media planning system may 100 conduct independent research to supplement ad campaign manager input. Ad campaign information may be submitted to the system 100 through ad buyer interface 104, for example. Exemplary types and formats of media planning information will described in greater detail in the discussion related to upcoming FIGs, but, in general, such information may include keywords related to the type of product or service to be advertised, the type(s) of media to be used in the ad campaign, the quantity of media to be used in the campaign (that is, an indication of the number of units of media to be used, such as: 30 seconds of radio or television, four column inches in a magazine, or 100,000 impressions on a website, for example), the budget for the ad campaign, and the calendar schedule of the ad campaign, for example.

Media planning database 102 may also include information related to ad sellers and to the media entity/entities they represent. Such information may be generated by a media planning system 100 gathering information related to ad sellers. Ad seller, and associated media outlet, information may be entered into the database 102 by an ad seller through the ad seller interface 106, for example. Media information may include the type of media (for example, radio, television, or digital media) represented by an ad seller, the “editorial” content of the media (for example, whether a magazine is a sports magazine, and, if so, whether it is a general sports magazine, or a magazine dedicated to fishing, or, if the media is digital, whether it is a website dedicated to sports, or, more specifically, to fishing), typical ad rates, the “reach” of the outlet (for example, how many viewers, how many impressions), or rank of the media outlet in a particular category, for example. In exemplary embodiments in accordance with principles of the inventive concepts, ad sellers may introduce to the database 102 information related to the availability and/or special pricing, for venues they represent.

In an exemplary embodiment in accordance with the principles of the inventive concepts, a media matching system 110 may employ ad campaign and ad media information from database 102 to determine whether a particular media outlet, and associated ad seller, may be suitable for an ad campaign that is represented in the database 102. For example, an ad campaign may have information associated with it that indicates that the campaign is directed to a line of fishing equipment. Matching system 110 may search media entries in the database 102 to determine which of the ad sellers having information in the database 102 represent media (for example, an ad seller representing media such as: a fishing magazine, a fishing website, or a fishing television show), that would be an appropriate fit for a fishing equipment ad campaign. In an exemplary embodiment, a matching system 110 may express a “degree of fit” which indicates not just whether one of a seller's media properties is a fit, but how precise the fit is. For example, a general sports magazine, or sports website may be a an appropriate fit for fishing equipment advertising, but a magazine or website exclusively devoted to fishing would be an even better, more precise fit. The “degree of fit” may be determined by an accumulation of points awarded for each of a variety of matching criteria, for example. Matching information may be in the form of keywords, data-card entries, IAB categories, or other information, for example.

The system 100 may employ a communications channel 108 to notify an ad seller that an ad campaign suitable for the media he represents is available for proposals. As will be described in greater detail in the discussion related to upcoming FIGs, the communications channel may be implemented in a variety of technologies, such as electronic mail, social networking, or text messaging, for example. The system 100 may automatically generate an initial notification to an ad seller in response to matching his media to an ad campaign. Matches may be presented to an ad buyer, allowing an ad buyer to winnow the selection, before notifications are sent. In an exemplary embodiment in accordance with the principles of the inventive concepts, an initial notification to an ad seller may keep the identity of an ad campaign manager, their contact information, and the associated ad campaign client confidential. Such confidential information may be revealed, for example, under control of an ad campaign manager, only after accepting an ad buyer's proposal.

The communications channel 108 may be configured to accept proposals from an ad seller, through ad sellers' interface 106, and to relay proposals to an ad buyer associated with the ad campaign for which the proposal is submitted. Ad seller's interface 106 may be configured to provide an ad seller with a standardized format for submission of proposals. In an exemplary embodiment in accordance with the principles of the inventive concepts, a system 100 may glean ad seller-related information from submitted proposals and store it in database 102. Such information may include the media types, outlets, and associated media content represented by an ad seller who submits a proposal. This information may be used, for example, to supplement matching information, such as the media type (also referred to herein as “channel”), outlet, and content (also referred to herein as “category”) he represents, submitted by an ad seller and to thereby automatically update matching information employed by matching system 110.

The communications channel 108 may be used for direct, two-way communications between an ad buyer, through ad buyer interface 104, and an ad seller, through ad seller interface 106, for example, after an ad buyer has accepted an ad seller's proposal. Ad buyer interface 104 may include a user interface and a computer interface, allowing users to post a campaign using an on-screen interface and/or using an application programming interface (API) with another system, for example. The communications channel 108 may also be used to alert an ad seller and/or ad buyer to the results of a matching process, for example and may employ any of a variety of communications technologies, such as electronic mail, text messaging, or facsimile, for example.

Ad buyer interface 104 may be configured to accept input from an ad buyer to allow an ad buyer to establish and monitor an ad campaign. To that end, as will be described in the description related to upcoming figures, ad buyer interface 104 may include formatted inputs that allow an ad buyer to readily enter critical ad campaign information, such as: media type, media quantity, campaign calendar schedule, campaign budget, and content category, for example. The ad buyer interface 104 may also allow an ad buyer to monitor the state of ad campaigns, whether active or inactive, and may allow access to ad campaigns of other ad buyers who are associated with the ad buyer (e.g., a co-worker), for example. Access to ad campaigns of others may be controlled and/or limited, for example.

Ad seller interface 106 may be configured to allow an ad seller to submit proposals for ad campaigns. As with the ad buyer interface 104, the ad seller interface 106 may present formatted input fields to allow a user to submit information in an efficient, effective manner. In addition to allowing an ad seller to submit a proposal, ad seller interface 106 may allow an ad seller to browse active ad campaigns in order to determine whether an active ad campaign may be suitable for a media property he represents. An ad seller may organize media properties he represents into media programs, with associated data as described in greater detail in discussions related to upcoming figures. As with ad buyer interface 104, ad seller interface 106 may include a user interface and a computer interface, allowing users to submit proposals using an on-screen interface and/or using an application programming interface (API) with another system, for example. In an exemplary embodiment in accordance with the principles of the inventive concepts, proposals may be submitted to an ad buyer with an indication of whether they were solicited (in response to a matching process, for example) or not (in response to an ad seller's browsing, for example) and, if solicited, some indication of “match” quality (e.g., very good match, good match, match) may be presented to an ad buyer. Such ranking of proposals may allow an ad buyer to more-efficiently select among several proposals, for example.

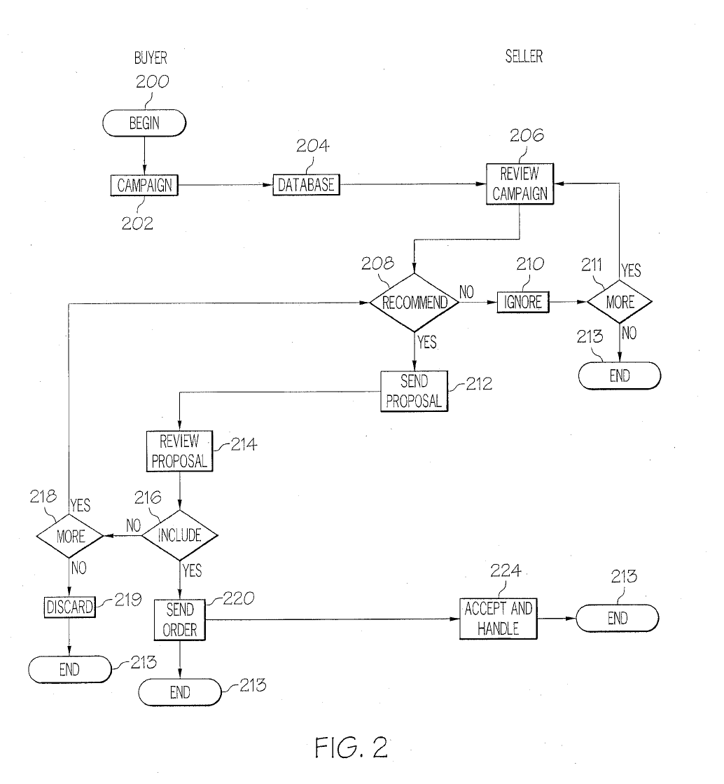

An exemplary embodiment of a process of launching an ad campaign in accordance with the principles of inventive concepts is depicted in the flow chart of FIG. 2. In this exemplary embodiment, it is assumed that an ad campaign database, such as database 102, described in the discussion relate to FIG. 1 has been established, that campaign-matching information for ad sellers has been entered, and that a matching system such as matching system 110 is being employed.

In this exemplary embodiment, an ad campaign begins in step 200 and proceeds from there to step 202 where an ad buyer generates the specifications for an ad campaign. Specifications for an ad campaign may include information about a mix of media types (channels), with associated ad quantities (for example, a thirty second radio spot, or, for a digital venue, one million impressions), overall budget for the ad campaign, and the calendar schedule of the campaign, for example. Once generated, using an ad buyer interface 104, for example, ad campaign specifications may be saved to an ad campaign database, such as ad campaign database 102, in step 204. Ad buyers may review and revise campaigns stored in the database and the system may extract information from ad campaign entries to track the progress of campaigns and to match media outlets and associated ad sellers to ad campaigns.

From step 204 a process in accordance with the principles of inventive concepts may proceed to step 206, where an ad seller may review a plurality of ad campaigns to determine whether to recommend a media outlet he represents for inclusion in the ad campaign. An ad seller may come to review ad campaigns in a variety of ways. He may, for example, browse active ad campaigns represented in an ad campaign database 102, he may browse active ad campaigns associated with buyers with whom he has worked before, or he may review one or more ad campaigns for which he has received a recommendation from a matching system 110, for example.

After reviewing an ad campaign in step 206 the process may proceed to step 208 where an ad seller determines whether to recommend one or more of his media properties for inclusion in an ad campaign. Ad campaign specifications entered into database 102 by an ad buyer associated with an ad campaign allow an ad seller to determine whether to submit a proposal for the ad campaign. In addition to standard data fields, such as “budget” and “channel” (also referred to herein as “media type”), descriptive comments entered by an ad buyer associated with a campaign many assist an ad seller in determining whether to submit a proposal to use media under his purview for the ad campaign. Information from the descriptive comments may also be extracted and saved by a system 100 and may be used, for a matching process, for example. Such comment information usage may include keyword storage, search, and matching, for example.

If the ad seller in question determines not to submit a proposal, the process proceeds to step 210, where the ad seller in question ignores the particular ad campaign he has reviewed. In step 211 the ad seller may return to step 206 and review additional ad campaigns for consideration or may proceed to end the process in step 213. As will be known by those in the art, the “end” step may include a re-entry into the process to, for example, search for and respond to other ad campaigns, for example.

If, in step 208 an ad seller decides to recommend a media outlet that he represents for inclusion in the ad campaign, he proceeds to step 212 where he submits a proposal. As will be described in greater detail in the discussion related to the following figures, in addition to price, media type, and media content information, an ad seller may add commentary and attach files (including, for example, a media kit) to the proposal in order to allow an ad buyer to make a more informed decision as to whether to include his media in the ad campaign. In exemplary embodiments in accordance with the principles of inventive concepts, the ad campaign proposal is submitted to the system 100, which acts as an intermediary between ad sellers and ad buyers. In this way, ad sellers may be made aware of ad campaigns they otherwise may not have been aware of, and ad buyers may be made aware of ad sellers and their associated media outlet clients they may not otherwise have been aware of Additionally, the ad buyer and entity represented by the ad buyer may be kept anonymous at this point in the creation of the ad campaign.

Once submitted by an ad seller, through ad seller interface 106, a proposal may be reviewed by an ad buyer in step 214. After review, the process may proceed to step 216, where an ad buyer determines whether to include the ad seller's media package in the ad campaign. If the ad buyer determines not to include the ad seller's media package, the process proceeds to step 218 where the ad buyer determines whether to solicit modification of the ad seller's proposal. If the ad buyer is interested in a revised proposal, the process proceeds from step 218 to step 208, where the ad seller reviews the ad campaign (and a request for a modified proposal) and proceeds from there as previously described. On the other hand, if the ad buyer determines not to solicit a proposal modification, the process proceeds to step 219 where the proposal is rejected. At this point, a message may be sent to the ad seller, indicating that the proposal has been rejected. An indication as to the reason the proposal was rejected may be included in such notification.

Returning to step 216, if an ad buyer decides to include media associated with the ad seller's proposal in the ad campaign, the process proceeds to step 220, where the ad buyer accepts the ad seller's proposal. At this point, database 102 may be updated to reflect an ad commitment associated with the accepted proposal. Because the campaign may be spread over different media from the same ad seller and/or different media from a plurality of ad sellers, the database may include an indication of what ad quantities remain to be purchased for the ad campaign, for example.

From step 220 the process proceeds to step 224, where the ad seller allocates the ad media which he has committed in the accepted proposal. From step 224, the process proceeds to end in step 213.

Although this exemplary embodiment of an ad campaign initiation process in accordance with the principles of the inventive concepts has been described in terms of a single ad seller and a single ad buyer, it is contemplated within the scope of the inventive concepts that a plurality of ad buyers and ad sellers will be connected through a system and process in accordance with the principles of the inventive concepts and that, for example, although an individual ad seller may ignore an ad campaign in step 210 and proceed from step 211 and end in step 213, other ad sellers will review the same ad campaign, proceed to step 212, and from there as previously described. Although a sequence of steps has been set forth in this exemplary embodiment, processes employing additional steps, fewer steps, or a different sequence of steps may be employed in accordance with the principles of the inventive concepts.

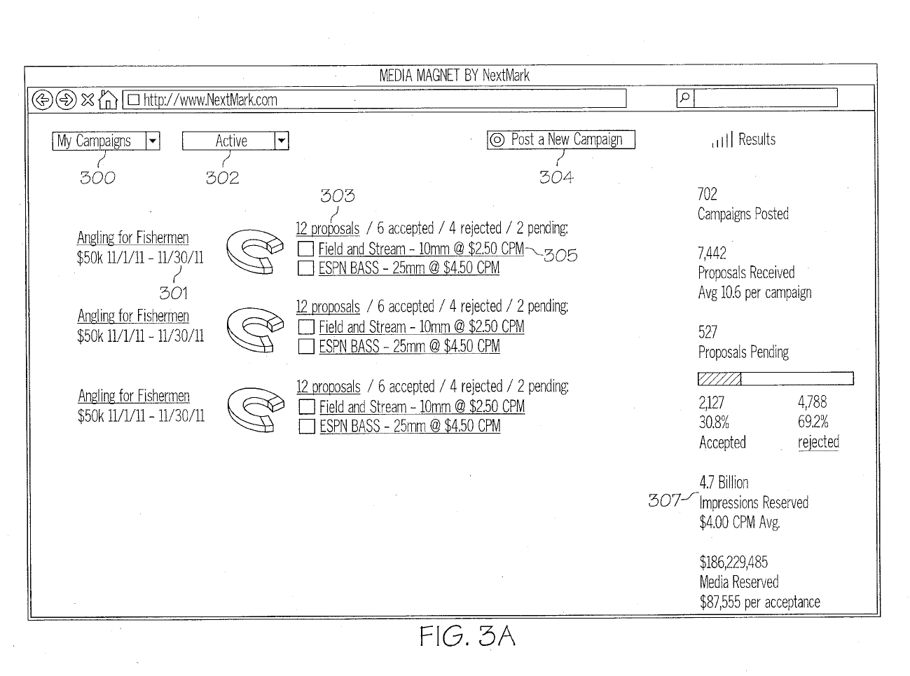

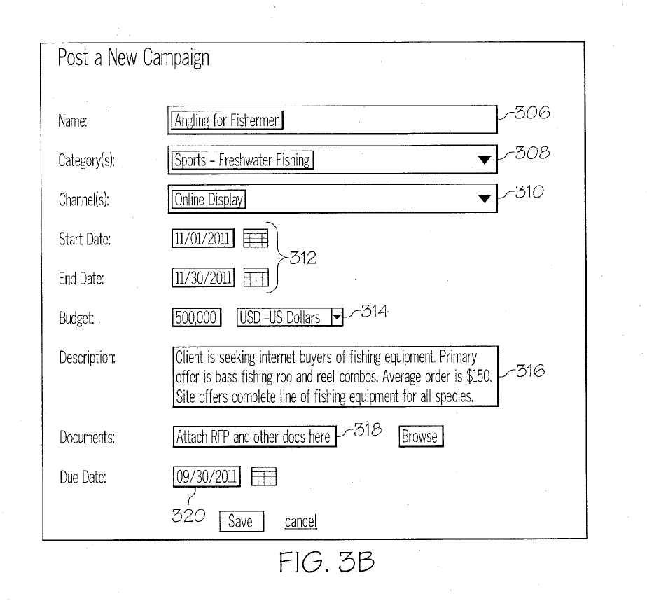

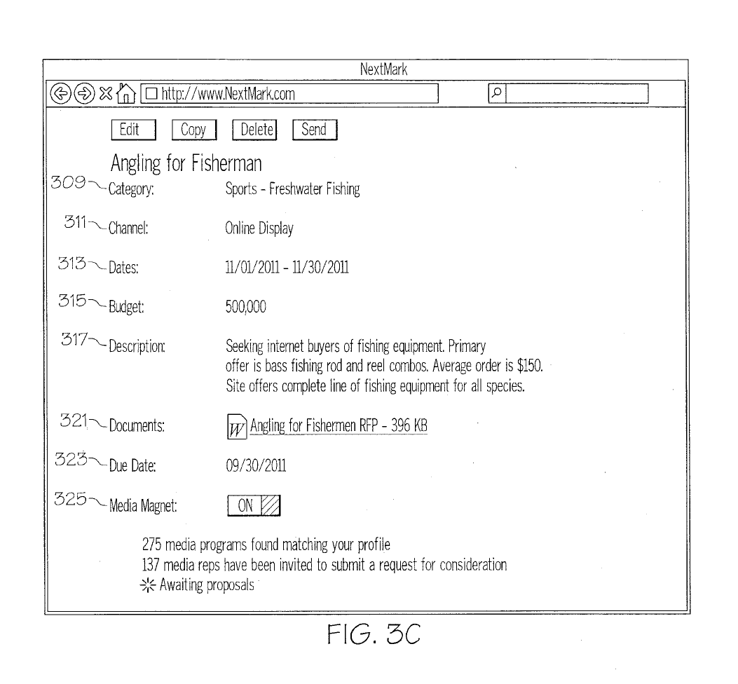

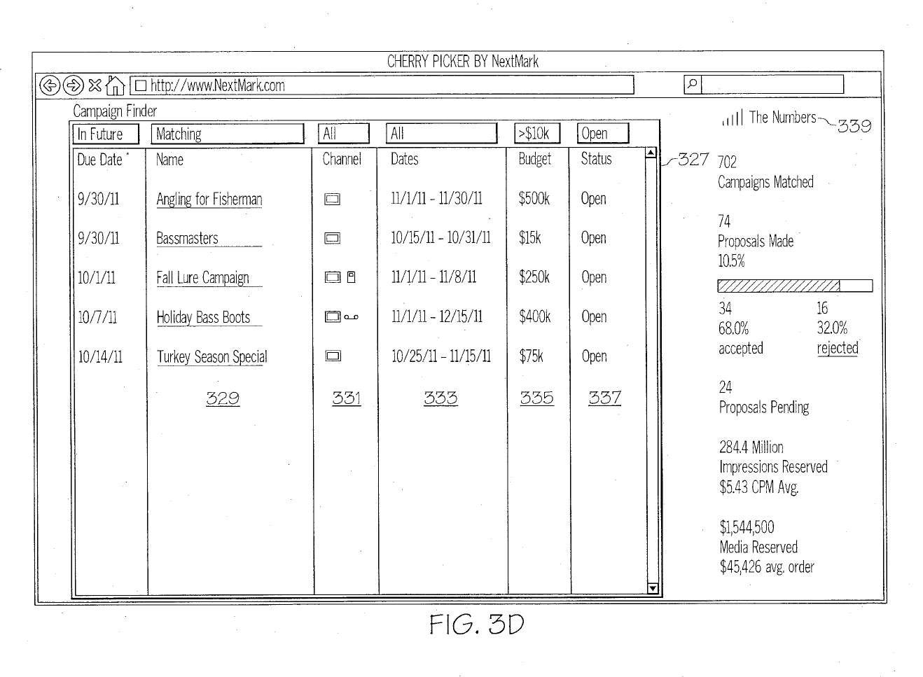

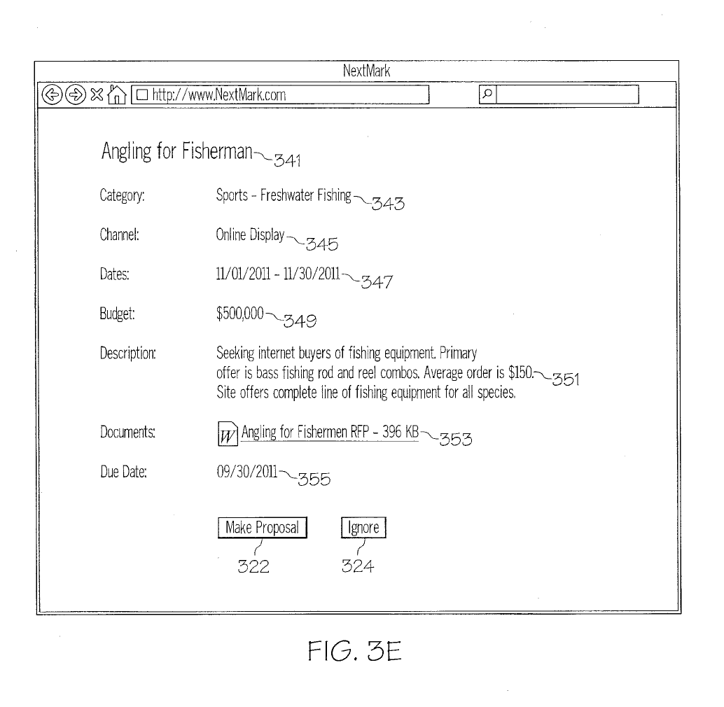

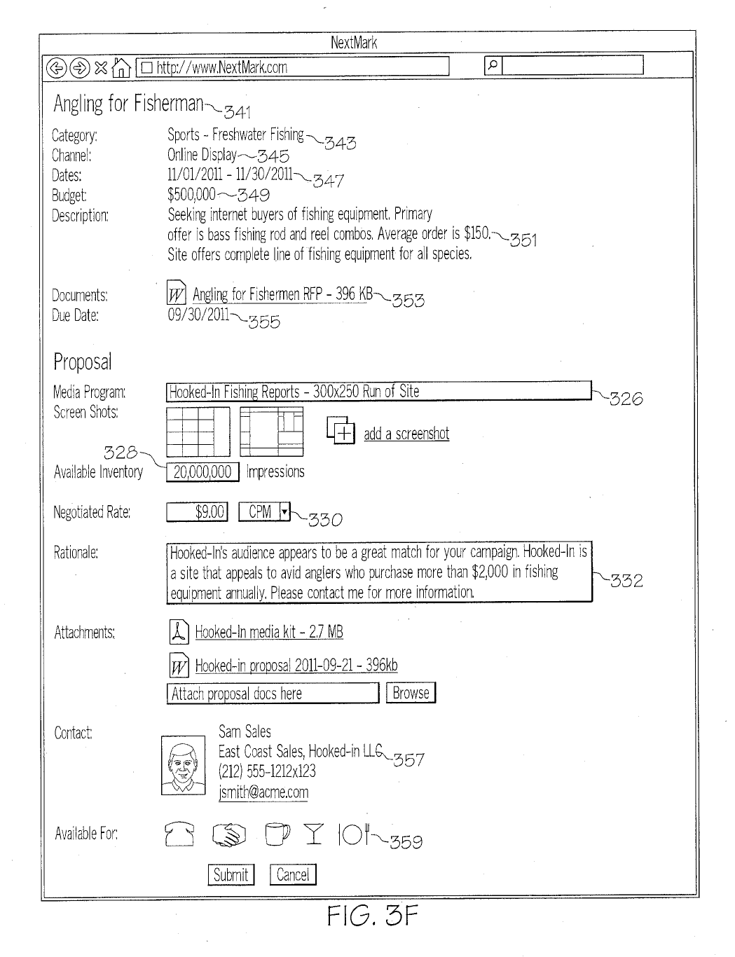

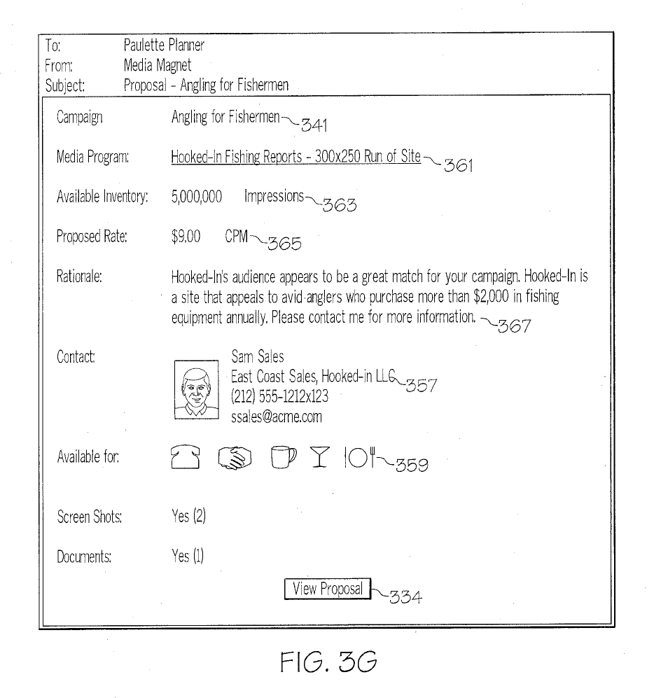

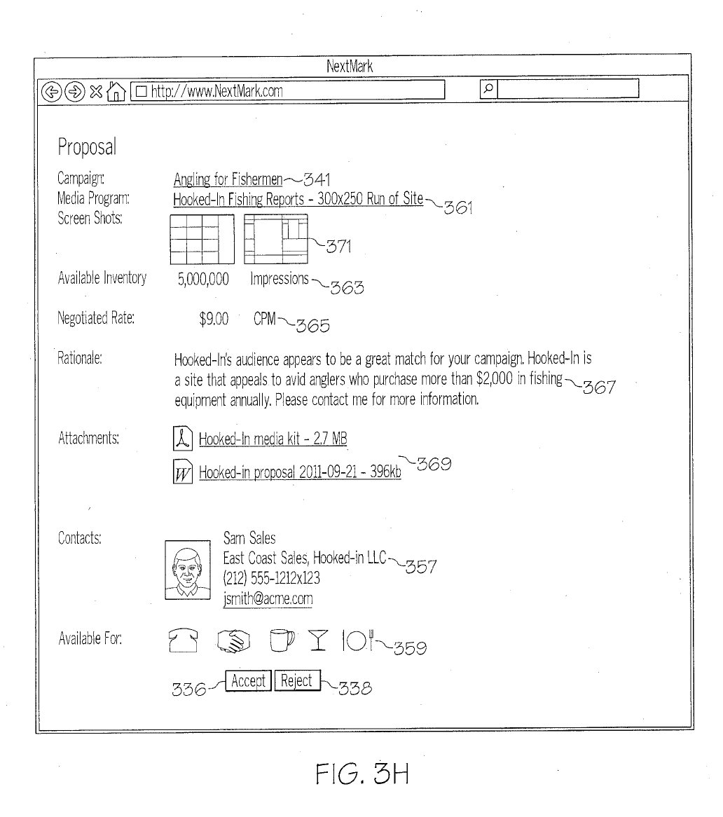

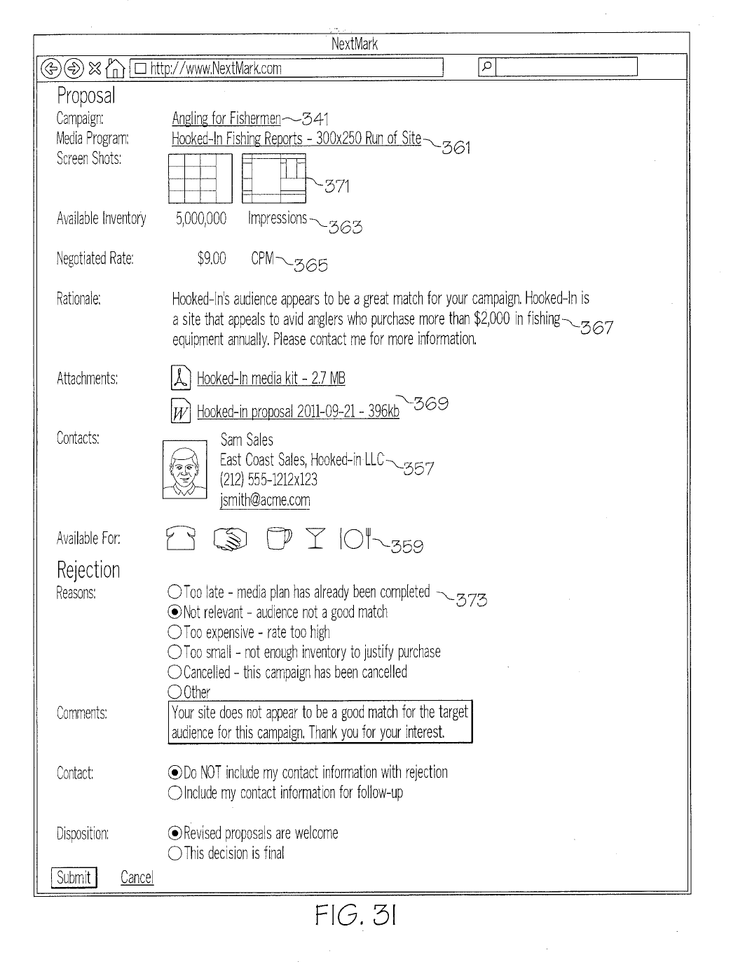

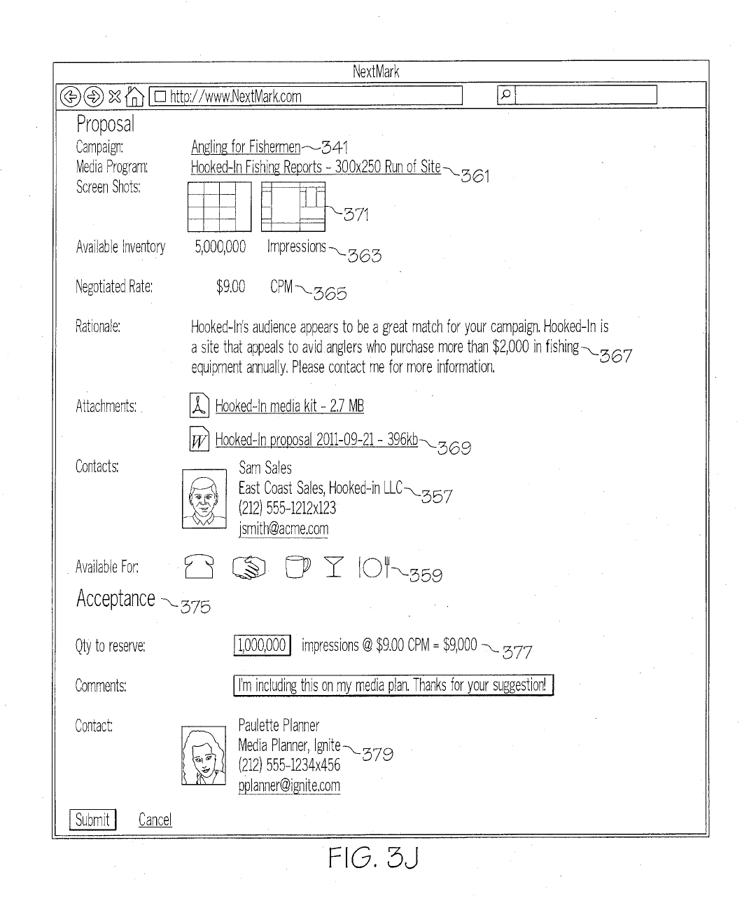

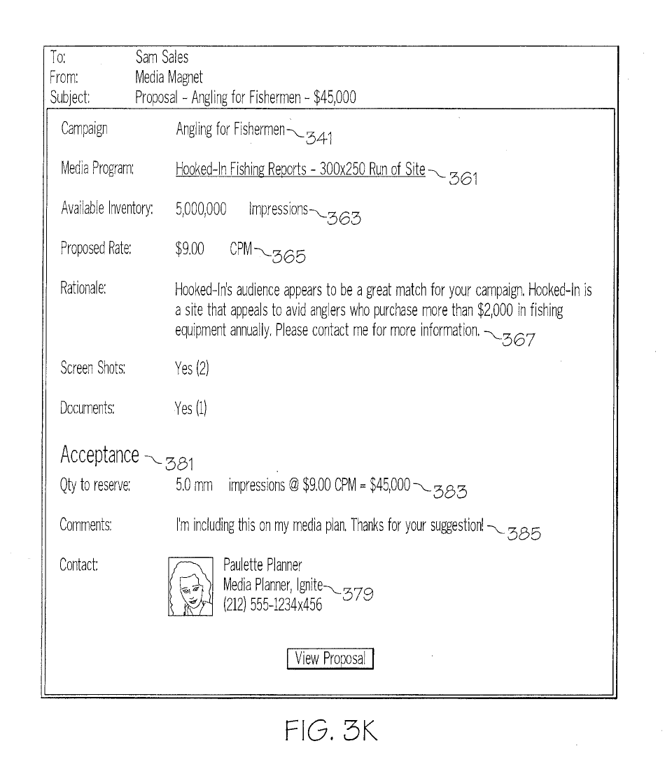

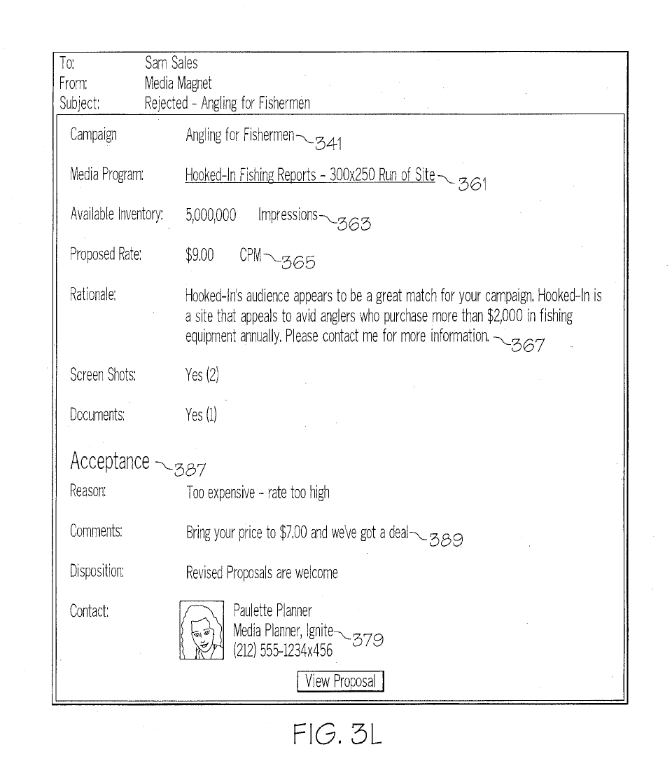

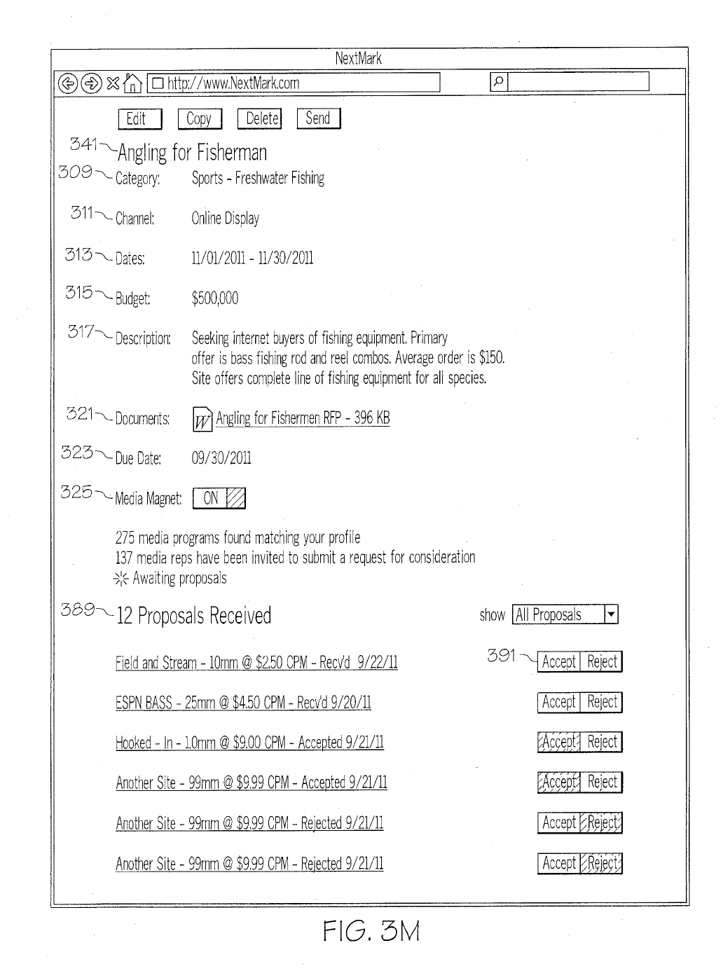

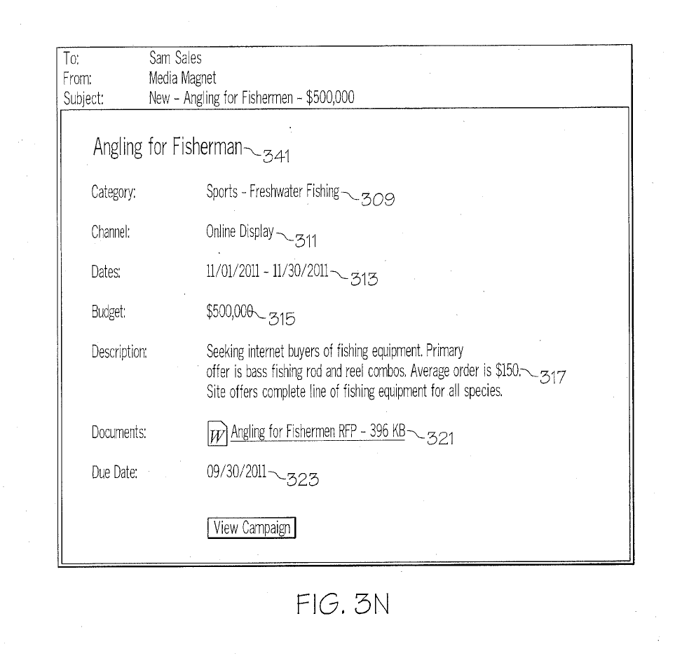

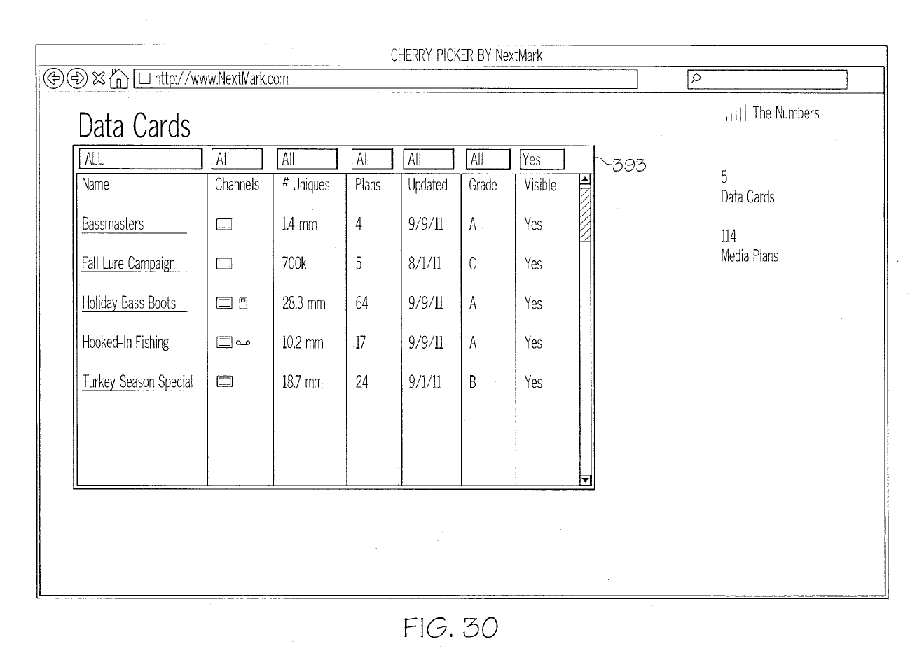

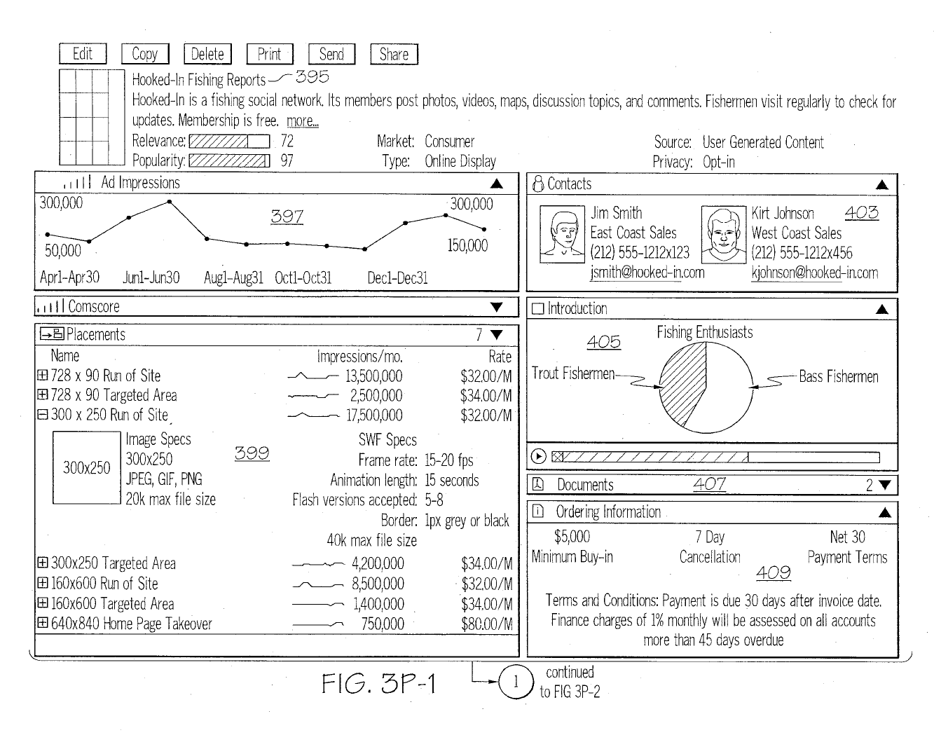

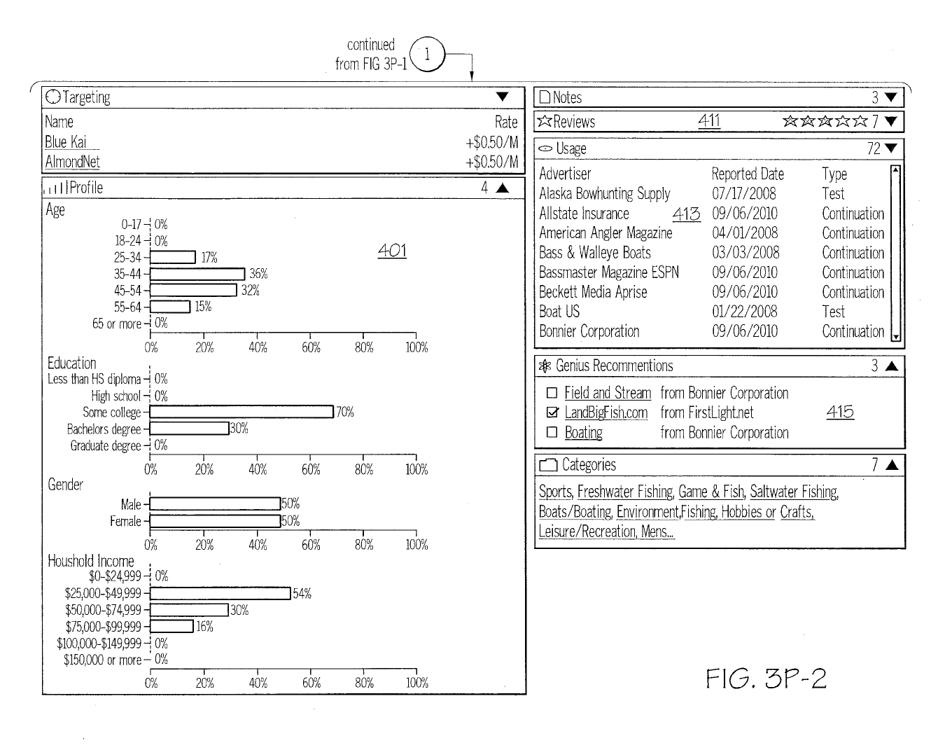

The screenshots of FIG. 3A through FIG. 3P will be used to expand upon the discussions of FIG. 1 and FIG. 2, with the screenshots roughly following a sequence of ad campaign launch and fulfillment, as set forth in the discussion related to the flow chart of FIG. 2. In particular, FIG. 3A depicts an ad buyer interface home page; FIG. 3B an ad buyer interface new campaign entry page such as may correlate to step 202 of the process in FIG. 2; FIG. 3C an ad buyer interface page that allows and ad buyer to check on the status of an ad campaign; FIG. 3D an ad seller interface home page presents an ad seller ad campaigns for which his media clients have been matched; FIG. 3E an ad seller interface display of requirements for a particular ad campaign, corresponding to step 206 of FIG. 2; FIG. 3F displays an ad seller interface page that allows an ad seller to create and send a proposal, corresponding to step 212 of FIG. 2; FIG. 3G displays an ad buyer interface page, roughly corresponding to step 214, that alerts an ad buyer to the presence of a proposal from and ad seller; FIG. 3H displays an ad buyer interface page, roughly corresponding to step 214, that allows an ad buyer to review the ad seller's proposal; FIG. 3I displays and ad buyer interface page that allows an ad buyer to reject an ad seller's proposal, roughly corresponding to step 219; FIG. 3J displays an ad buyer interface page in which an ad buyer accepts an ad seller's proposal, roughly corresponding to step 220. FIG. 3K displays an ad seller interface page in which an ad buyer indicates to an ad seller that the ad seller's proposal has been accepted, roughly corresponding to step 224; FIG. 3L displays an ad seller interface page in which an ad buyer indicates that his proposal has been rejected, roughly corresponding to step 219; FIG. 3M is a ad buyer interface display that allows an ad buyer to examine the status of an ad campaign; FIG. 3N is an ad seller interface page in which an ad seller is notified that his media is a match for a new campaign; FIG. 3O is a listing of data cards, the information within which may be used by matcher 110 to match ad campaigns to media programs represented by data cards; and FIG. 3P is an exemplary embodiment of a data card representing a media program.

The screenshot of FIG. 3A provides a view of an exemplary embodiment of a home page presented to an ad buyer by an ad buyer interface 104 in accordance with the principles of inventive concepts. In this exemplary embodiment an ad buyer may view the status of ad campaigns conducted by an organization with which the ad buyer is associated. Such ad campaigns may be active or inactive (e.g., completed or “booked”) and may be under the control of the ad buyer using the interface or may be conducted by fellow-employees of the organization. In this exemplary embodiment, an ad campaign menu box 300 has been set to “my campaigns” and the status menu box 302 has been set to “active,” revealing a list of the active ad campaigns assigned to the ad buyer using the ad buyer interface 104. In this exemplary embodiment, information 301 related to an “Angling for Fisherman” ad campaign includes general campaign information, including budget ($50,000), and calendar schedule, or runtime (Nov. 1 through Nov. 30, 2011), at the right of the campaign entry. Additional fields 303 include information related to the number of proposals received (12), the number of proposals accepted (6), the number of proposals rejected (4), and the number of proposals still pending (2). In this exemplary embodiment, more detailed information related to the two pending proposals 305 is displayed below the general proposal tracking line; Field and Stream has proposed 10 mm (ten million) impressions, at a cost of $2.50 per thousand impressions (CPM). In this exemplary embodiment, ads are placed in digital media and the rate is based on the number of impressions. An “impression” may be defined as the viewing of an ad, for example. Such information may be used by an ad buyer to track the progress of one or more ad campaigns, for example.

Statistics related to the entire organization are displayed in a vertical column 307 along the right-hand side of the display. Such statistics may include: the number of ad campaigns posted, the number of proposals received, the average number of proposals received per campaign, the number of proposals pending, the number and percentage of proposals accepted or rejected, the number of impressions reserved, and the monetary value of media reserved, for example. The “impressions reserved” entry refers to the number of impressions being set aside, or provisioned, for use by the ad buyer's organization during negotiation processes. Reserving impressions in this fashion ensures that they are not sold to more than one party, thereby “overbooking” a media outlet. Options associated with the statistics include linking to the reason(s) project(s) have been rejected. A control button 304 allows an ad buyer to enter, or “post,” a new ad campaign. In an illustrative embodiment the information displayed on this page, along with additional ad campaign information, is stored and updated by a media planning system 100 and method in accordance with the principles of inventive concepts.

If the “post campaign” button 304 is activated, the ad buyer interface 104 presents a formatted input screen such as displayed in an exemplary embodiment of the inventive concept as depicted in the screenshot of FIG. 3B. In this exemplary embodiment, a dialog box 306 allows an ad buyer to enter the name of a new ad campaign. Dialog box 308 provides a pull down menu of content categories. In this exemplary embodiment, categories may be standardized categories, such as Interactive Advertising Bureau (IAB) categories. Such categories may be hierarchical (e.g., in this exemplary embodiment, a top-level category is “fishing,” and, at a more specific level, freshwater fishing), and allow ad buyer and ad seller to communicate ad information in a standardized manner. A matching module 110 may employ such category information to match an ad buyer's campaign with relevant potential media outlets and their associated ad sellers, for example. A dialog box 310 permits an ad buyer to specify the media channel, or media type (e.g., radio, television, magazine, or online display), to be used in the campaign. In this exemplary embodiment, the media type is “online display.” The entry of start and end dates is aided by dialog boxes along with calendar buttons 312, which permit an ad buyer to enter dates either by typing the dates into the boxes or by clicking on calendar entries, for example. The budget for an ad campaign may be entered using dialog boxes 314. A detailed, narrative, description of the ad campaign, its product descriptions, and targeted audience, may be entered in a “description” dialog box 316. Documents associated with the ad campaign may be attached using dialog box and associated Browse button 318. Such documents may include a request for proposal document that may provide more detail regarding an ad campaign, for example. The due date for proposals may be entered in dialog box 320 with the aid of an associated calendar. A media management system 100 may store all such information in database 102, for example, and may update such information as an ad campaign progresses. Various forms of information may be extracted from such entries for statistical reports and analyses and for matching of media campaign to media outlet, for example.

In an exemplary embodiment of a media planning system 100 in accordance with the principles of the inventive concepts, an ad buyer interface 104 may provide an ad buyer the opportunity to place and monitor ad campaign requirements, as indicated by the screenshot of FIG. 3C. In this illustrative embodiment, an ad buyer has called up details for the “Angling for Fisherman” campaign. The campaign's category 309 (Sports-Freshwater Fishing), channel 311 (Online Display), run dates 313 (Nov. 1 through Nov. 30, 2011), budget 315 ($500,000), and description 317 are listed for review. Attachments 321, such as a request for proposals, provide greater detail for review. The due date 323 for proposals is displayed as a ready reminder for the ad campaign creator, and a summary, indicating the number of media programs found matching the ad campaign profile, and the number of media ad sellers who have been invited to submit media proposals. Not all media programs, or outlets, matching an ad campaign's profile need be invited to submit a proposal, or “request for consideration.” As the ad campaign has already been posted in this screenshot, the edit, copy, delete, and send buttons will allow an ad buyer to perform the associated operation on a posted campaign. During the course of a campaign, an ad buyer may switch the “Media Magnet” 325 button to the OFF position when, for example, the ad buyer has received sufficient response to the posting of the ad campaign.

In an exemplary embodiment in accordance with the principles of inventive concepts a system 100 may include an ad seller interface 106 which provides a home page, such as illustrated by the screenshot of FIG. 3D. Filters 327 may be employed to allow an ad seller to obtain information related to campaigns represented in database 102. In this exemplary embodiment, upcoming (“in future”) ad campaigns for which an ad seller's media programs have been matched are listed 329, along with the associated channel 331 (e.g. digital, print, television, etc.), dates the campaign is to run 333, campaign budget 335, and status 337 (open for proposals, or completed). Additional campaign-related information may be displayed, for example, vertically, along the right side of the screen 339. Such information may include “global” statistics for the organization with which the ad seller is associated, to a subset of the organization's ad sells statistics, statistics related to the ad seller himself, or to a combination of such statistics, for example. In this exemplary embodiment, statistics for the entire organization are displayed and include: the number of campaigns matched (702), the number of proposals made (74) and the percentage of proposals made in response to the matched campaigns (10%), the numbers and percentages of those proposals that were accepted or rejected, and the number of proposals that are pending. Such information may be used by an ad seller as to determine whether more or less resources should be devoted to matching ad campaigns, for example. The total number of impressions reserved (284.4 million) and the average cost ($5.43 CPM) are also displayed. The total dollar amount associated with reserved media ($1,544,500.00) and average per order ($45,426.00) are also displayed. Such ad seller information may be stored and updated in a database 102 in accordance with the principles of inventive concepts and may be used for ad campaign analyses, summarization, and matching processes, for example.

In the screenshot of FIG. 3E, an exemplary ad seller interface display provides an ad seller with a detailed view of the requirements for a particular ad campaign: “Angling for Fishermen.” An ad seller may reach this screen, for example, by selecting this particular campaign from the list of campaigns presented in the screenshot of FIG. 3D, roughly corresponding to step 206 of FIG. 2. In addition to the information placed in the system 100 by an ad buyer (e.g., Category, Channel, Dates, etc.) the ad seller interface 106 provides buttons to allow an ad seller to make a proposal 322, or to ignore 324 the ad campaign. In this exemplary embodiment, the title 341, category 343, channel 345, dates 347, budget 349, description 351, documents 353, and due date 355 entries correspond, respectively, to entries 306, 308, 310, 312, 314, 316, 318 and 320 of FIG. 3B made by an ad buyer in the course of creating an ad campaign.

The screenshot of FIG. 3F displays an ad seller interface page that allows an ad seller to create and send a proposal, roughly corresponding to step 212 of FIG. 2. In this exemplary embodiment, a dialog box 326 allow an ad seller to enter a proposed media program (which may, for example, be a media venue or outlet, such as the website “Hooked-in Fishing Reports”) along with media quantity (this may be an IAB preset amount, such as an ad size of 300×250 pixels along with a number of impressions, for example), and location (Run of Site, or, anywhere, in this exemplary embodiment). Screen shots of the proposed website may be attached to the proposal, and a dialog box 328 provides an indication of how many impressions may be available during the time the ad campaign is to run. Dialog box 330 provides an indication of the rate for the available ad space and dialog box 332 allows an ad seller to indicate his reasons for believing that this particular media venue would be a good fit for the ad campaign. The ad seller interface 106 accommodates attachments, such as a media kit for the proposed media venue and a proposal specific to the ad campaign in this screenshot. Contact information 357 and some indication of the availability for contact 359 (e.g., telephone, meeting, etc.) are also provided.

An ad buyer may be presented with an ad buyer's proposal through an electronic mail message, as indicated in the screenshot of FIG. 3G. Such a message may be sent over the communication system 108, for example. In this exemplary embodiment, the email has been formatted to allow both ad seller and ad buyer ready access to critical information, including: the name of the ad campaign for which the email is sent, the media program 361 (Hooked in Fishing Reports), available inventory 363 (5,000,000 impressions), proposed rate 365 ($9.00 CPM), contact information 357 for the ad seller, an indication of the ad seller's availability 359 (for example, icons representing: telephone call, face-to-face office meeting, meeting for coffee, meeting for drinks, or meeting for dinner, for example. A “Rationale” field 367 may allow an ad seller to add anything that might help an ad seller justify the ad buyer's use of the media program represented by the ad buyer. This might include information related to the editorial content of a proposed media program: “Hooked in Fishing Reports will be running a piece about crappie fishing in the Midwest through November,” for example. Button 334 allows an ad buyer to view the submitted proposal. As previously indicated, communications system 108 may employ any of a variety of communications technologies and techniques, including: email (as in this exemplary embodiment), social networking, text messaging, personal digital assistants, smart phones, electronic tablets, cellular telephone, or wireless internet access (e.g., WiFi), for example.

The screenshot of FIG. 3H displays an ad buyer interface page roughly corresponding to step 214 of FIG. 2. In this exemplary embodiment, the ad buyer interface 104 allows an ad buyer to review the ad seller's proposal and, using buttons 336,338 may, respectively, accept or reject the proposal submitted by the ad seller. In accordance with principles of the inventive concepts, other choices, such as, “I'm interested, but need more information,” may be included as a choice, for example. Attachments 369 may include more detailed information, such as a media kit and detailed proposal, for example. Screenshots 371 may provide an ad buyer with a more detailed view, along with an overall sense, a “gestalt,” of the ad seller's proposed medium. The screenshot of FIG. 3I displays an ad buyer interface page that appears in response to an ad buyer activating the “reject proposal” button 336 of the previous screen. In this exemplary embodiment, the screen provides a formatted rejection response 373 to allow an ad buyer to reject an ad seller's proposal, roughly corresponding to step 219 of FIG. 2. In addition to predetermined reasons for a rejection (e.g., proposal is too late, audience is not a good match, etc.), a “comment” dialog box allows an ad buyer to expand on the reason(s) for rejection. As indicated by the “Contact” field, the ad buyer still maintains control over their contact information at this point in the negotiations. That is, the system 100 allows an ad buyer to remain anonymous and keep their client information confidential, even to this point in the negotiations for the ad campaign. Additionally, preset selections allow an ad buyer to indicate to the ad seller whether the rejection is final or revised proposals will be entertained.

Alternatively, if an ad buyer elects to accept an ad seller's proposal (roughly corresponding to step 220 of FIG. 2), the ad buyer interface 104 may present a screen, as in FIG. 3J, that repeats the ad seller's proposal, conveys the ad buyer's acceptance 375, and gives an indication of the amount of media to reserve 377 (e.g., 1,000,000 impressions) at what rate (e.g., $9.00 CPM=$9,000.00). The ad buyer also may include their own contact information 379 at this point, as indicated by the “filled in” contact information field in this exemplary embodiment. The ad seller's counterpart display, FIG. 3K displays an ad seller interface page in which an ad buyer indicates to an ad seller that the ad seller's proposal has been accepted 381, roughly corresponding to step 224 of FIG. 2. The acceptance may include the quantity to reserve 383 and comments 385, for example. The ad seller interface 106 may present a display corresponding to a rejection such as in the exemplary screenshot of FIG. 3L, roughly corresponding to step 219 of FIG. 2. In this exemplary embodiment, a formatted email message using communications channel 108 conveys the rejection 387, but, in a comment section 389, invites the ad buyer to modify terms in order to proceed with negotiations.

An ad buyer interface 106 may allow an ad buyer to check on the status of a campaign at any point in the campaign, for example. In an exemplary embodiment in accordance with the principles of the inventive concept the screenshot of FIG. 3M includes updated information related to the illustrative “Angling for Fishermen” campaign in which detailed information related to various proposals that have been received is displayed 389 and buttons 391 are provided for an ad buyer to accept or reject proposals. Summary information, including information contained in the original request for proposals, may also be displayed on such a screen, for example. In this exemplary embodiment in accordance with the principles of inventive concepts, the bottom two listed proposals have been rejected, as indicated by the darker shading of the “rejected” segments of their associated accept/reject buttons, the middle two proposals have been accepted, as indicated by the darker shading of the “accepted” segments of their associated accept/reject buttons, and the top two proposals have yet to be accepted or rejected, as indicated by both the lack of shading and the use of present tense.

In the exemplary embodiment of FIG. 3N an ad seller interface page indicates to an ad seller that media he represents is a match for a new campaign, the “Angling” campaign used as an example throughout the discussion of FIG. 3. This notification roughly corresponds to step 206 of FIG. 2. Upon viewing the notification, an ad seller may activate a “View Campaign” button, for example, to uncover the details of the ad campaign and to respond by submitting a proposal, as previously described.

In the illustrative screenshot of FIG. 3O an ad seller interface page allows an ad seller to organize ad media information into “data cards” and to review the status of ad campaigns associated with such media presented in data cards. Information “on” (that is, associated with) data cards may be employed by matcher 110 to match ad campaigns to media programs, for example. In this exemplary embodiment in accordance with principles of inventive concepts, pull-down menus 393 allow an ad seller to filter among ad campaigns and media programs according to name, channels, impressions, media plans, and “grades” (which may provide an indication of client satisfaction), for example.

The illustrative screenshot of FIG. 3P displays information such as may be included in a data card, for example. In this exemplary embodiment a title field 395 indicates that the data card relates to a media program for Hooked-in Fishing Reports. Information, which, as previously indicated, may be employed to match ad campaigns to media programs, may include the actual number of ad impressions 397 (which may differ from a projected number), on a monthly or weekly basis, for example. The number and type of placements 399, and demographic information related to placements may also be included. In an exemplary embodiment in accordance with inventive concepts, all such information may be accepted, monitored, updated, and stored by an ad seller interface 106 in a database 102, for example. In exemplary embodiments, detailed information 401 related to members of the Hooked-in Fishing Reports social network site may be used by an ad seller to assess the suitability of the site for ad placements. Such information may also be used by matcher 110 for matching purposes, for example. Contact information for ad sellers who represent Hooked-in Fishing Reports may be included in a data field 403. In an exemplary embodiment, an introduction 405 to the site may include video, graphic, slide, or information in other formats that synopsizes the site, its members, and its primary focus, for example. A pull-down menu 407 may provide access to documents such as media kits, for example. Ordering terms may be listed in a data field 409 and reviews of the site may be accessed through pull-down menu 411. Clients who have previously advertised on the site may be listed in data field 413. A recommendation field 415 may include other media outlets that may share at least some aspects, such as similar audiences, of the present site (that is, Hooked-in Fishing Reports). An ad seller may use this feature to create (e.g., by checking a box, as illustrated) and maintain a list of prospective viewers and associated media outlets.

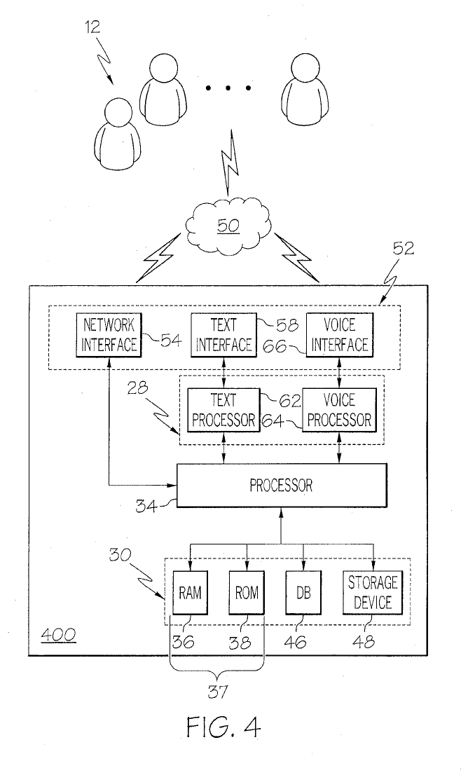

FIG. 4 is an exemplary block diagram of a computer architecture or system 400 within which an ad campaign management system (see FIG. 1) may be implemented. The computer system 400 includes at least one processor 34 (e.g., a central processing unit (CPU)) that stores and retrieves data from an electronic information (e.g., data) storage system 30. As will be appreciated by those skilled in the art, while computer system 400 is shown with a specific set of components, various embodiments may not require all of these components and could include more than one of the components that are included, e.g., multiple processors. It is understood that the type, number and connections among and between the listed components are exemplary only and not intended to be limiting.

In the illustrative embodiment, processor 34 is referred to as CPU 34, which may include any of a variety of types of processors known in the art (or developed hereafter), such as a general purpose microprocessor, a digital signal processor or a microcontroller, or a combination thereof. CPU 34 may be operably coupled to storage systems 30 and configured to execute sequences of computer program instructions to perform various processes and functions associated with the ad campaign management system, including the storing, processing, formatting, manipulation and analysis of data associated with the ad campaign management system (e.g., ad seller data, ad buyer data, ad campaign data). The computer program instructions may be loaded into any one or more of the storage media depicted in storage system 30.

Storage system 30 may include any of a variety of semiconductor memories 37, such as, for example, random-access memory (RAM) 36, read-only memory (ROM) 38, a flash memory (not shown), or a memory card (not shown). The storage system 30 may also include at least one database 46, at least one storage device or system 48, or a combination thereof. Storage device 48 may include any type of mass storage media configured to store information and instructions that processor 34 may need to perform processes and functions associated with the ad campaign management system. As examples, data storage device 48 may include a disk storage system or a tape storage system. A disk storage system may include an optical or magnetic storage media, including, but not limited to a floppy drive, a zip drive, a hard drive, a “thumb” drive, a read/write CD ROM or other type of storage system or device. A tape storage system may include a magnetic, a physical, or other type of tape system.

While the embodiment of FIG. 4 shows the various storage devices collocated, they need not be as they could be remote to each other, to processor 34 or both. Storage system 30 may be maintained by a third party, may include any type of commercial or customized database 46, and may include one or more tools for analyzing data or other information contained therein. In particular, database 46 may correspond, all or in part, to database 102 as described in the discussion related to FIG. 1, and may include matching tools for matching ad campaigns to ad sellers, as previously described.

In various embodiments, data storage system 30 may be configured to store data representative of the users 12 (such as ad sellers or ad buyers), ad campaigns 14, or both. Data representative of users 12 may include data that is not specific to the ad campaign management system, such as a name, a delivery address, a zip code, a credit card number, a social security number, a phone number, an email address, or a combination thereof, as examples. Data representative of a user may include data associated with the user and the ad campaign management system, such as, for example, a username, a password, a user rating or ranking, a user comment, an accept/reject match percentage, a member or account number, an access code, and so on. Data representative of ad campaigns 14 may include data associated with one or more ad campaigns, such as: budget, scheduled dates, media type, etc.

As an example, database 46 may include any hardware, software, or firmware, or any combination thereof, configured to store data. Specifically, database 46 may be configured to store data and information representative of one or more of the plurality of users 12, one or more ad campaigns 14, or both. In some embodiments, database 46 may include one or more fields, wherein a field may be an element of a database record in which one piece of information may be stored. In particular, a field may be configured to store an element of data representative of one or more of the users 12, one or more of ad campaigns 14, or both.

In some embodiments, one or more storage device in the data storage system 30 (e.g., database 46) may be configured to store an ad campaign category, schedule, budget, media type, media capacity, or other data associated with the ad campaign management system. Data associated with the ad campaign management system 100 may be stored in storage system 30 using any suitable database format, such as, for example, a relational database, a hierarchical database, or any suitable schema. Data storage system 30 may be configured to store information in a format configured to enhance operations of CPU 34 or other functions of the ad campaign management system.

Computer system 400 may include or interface with one or more security systems (not shown), configured to at least partially restrict or control access to one or more components of computer system 400. Security systems may include hardware, software, firmware or a combination thereof, such as, for example, a firewall, password protection software, user authentication software, encryption software and the like. In some embodiments, security systems may be configured to limit a function of the ad campaign management system, limit access to data associated the ad campaign management system, or both.

In some embodiments, computer system 400 may be configured so that select data contained within storage system 30 may be inaccessible to one or more of the users 12. Computer system 400 may also be configured to permit ad campaign information exchange only between select users from the plurality of users 12, such as, for example, between ad buyers or sellers within the same organization, users with certain access privileges, or any combination thereof, as examples.

Computer system 400 may include a network interface system or subsystem 54 configured to enable ad-campaign initiation and management interactions with the plurality of users 12 via one or more network 50. As such, computer system 400 may be configured to transmit or receive, or both, one or more signals related to the functions of the ad campaign management system 100. A signal may include any generated and transmitted communication, such as, for example, a digital signal or an analog signal. As examples, network 50 may be a local area network (LAN), wide area network (WAN), virtual private network (VPN), the World Wide Web, the Internet, voice over IP (VOIP) network, a telephone or cellular telephone network or any combination thereof. The communication of signals across network 50 may include any wired or wireless transmission paths. The ad campaign management communications system 108 previously described may employ the one or more networks 50, for example, to enable communications between ad buyers and ad sellers.

To enable communications via network 50, computer system 400 may include a set of interfaces 52 and a set of processors 28, 34. The set of processors 28 may include a text processor 62 and a voice processor 64, along with CPU 34. The set of interfaces may include a network interface 54, a text interface 58 and a voice interface 66, as shown in this embodiment. As mentioned above, network 50 may represent a combination of networks configured to transmit and receive communications with computer system 400, via any of the set of interfaces 52.

CPU 34 may be operably coupled to network interface system 54 for exchanging typical computer network information, e.g., via the Internet, a LAN, WAN, VPN or some combination thereof. Network interface system 54 may be configured to permit communication between and among the users 12 and computer system 400, for example using an Internet protocol (IP) or other network-based protocol. In such cases, network interface system 54 may be configured to utilize TCP/IP, HTTP, DNS or any other application, transport, network, or link protocol, or combination of the foregoing.

Text interface 58 may be operably coupled to a text processor 62 configured to process received text message and text messages to be transmitted. Text interface 58 may be configured to permit text-based communication between users 12 and computer system 400. For example, in combination, text interface 58 and text processor 62 may include functionality to communicate with a two-way pager, a personal digital assistant (PDA), a cell phone, a computer, a laptop, a tablet, a terminal, or any other suitable electronic device, whether wired or wireless. Text processor 62 may include an email system configured to transmit, receive, or process, email messages or a combination thereof. Text processor 62 may also include an instant-messaging (IM) system, a two-way paging system or other system configured to transmit, receive, or process, or a combination thereof, text-based information. As will be appreciated by those skilled in the art, such systems may also provided mechanisms for transferring files between devices. Such files may include any of a wide variety of content.

Voice interface 66 may be operably coupled to a voice processor 64 configured to process received voice information and voice data to be transmitted. Voice interface 66 may be configured to permit voice-based communication between and among the users 12 and computer system 400. For example, in combination, voice interface 66 and voice processor 64 may be configured to enable interaction with a cell phone, a fixed-line telephone, a VOIP device or other similar device, or combinations thereof. For example, voice interface 66 may be configured to transmit, receive, or both digital or analogue signals using wired to wireless communications devices and systems, such systems may include telephone, cellular telephone and VOIP systems, as examples.

In some embodiments, the operable connections between components of computer system 400 may be other than as shown in FIG. 4. For example, data storage system 30 may be operably connected to communication processors 28 or interfaces 52, or both, such that users from the plurality of users 12 may modify data stored in data storage system 30 using such interfaces and processors.

In various embodiments, systems that may be associated with the ad campaign management system 100 may include one or more systems configured to provide additional functions associated or useful in conjunction with the media planning system. For example, systems associated with the ad campaign management system may include a tracking system (not shown) configured to track the completion of ad campaign agreements and the fulfillment of such agreements.

It is also contemplated that the ad campaign management system may be implemented using one or more computer systems 400. For example, various embodiments of an ad campaign management system may include a plurality of computer systems 400, components of computer system 400, or other systems associated with the media planning system. A large number of users 12 or heavy usage may, for example, require relatively high computational power to efficiently operate the ad campaign management system.

While the present inventive concepts have been particularly shown and described above with reference to exemplary embodiments thereof, it will be understood by those of ordinary skill in the art, that various changes in form and detail can be made without departing from the spirit and scope of the present inventive concepts described and defined by the following claims.

What is claimed is:

1. A method performed in a computer system having one or more processors executing a unique set of instructions, the method comprising:
generating an ad campaign database;
providing an ad buyer interface to the ad campaign database; and
providing an ad seller interface to the ad campaign database.

2. The method of claim 1, further comprising:
accepting ad campaign information through the ad buyer interface.

3. The method of claim 2, wherein the ad campaign information includes indicia of the ad campaign's targeted media type.

4. The method of claim 2, wherein the ad campaign information includes indicia of the ad campaign's targeted budget.

5. The method of claim 2, wherein the ad campaign information includes indicia of the ad campaign's targeted media type.

6. The method of claim 2, wherein the ad campaign information includes indicia of the ad campaign's calendar schedule.

7. The method of claim 2, wherein the ad campaign information includes indicia of the ad campaign's content.

8. The method of claim 2, wherein the ad campaign information includes matching information.

9. The method of claim 1, further comprising accepting media information through the ad seller interface.

10. The method of claim 9, wherein the media information includes a measure of media available for advertising.

11. The method of claim 9, wherein the media information includes indicia of content type.

12. The method of claim 9, wherein the media information includes matching information.

13. The method of claim 1, further comprising:
accepting ad campaign information through the ad buyer's interface, the ad campaign information including matching information;
accepting ad media information through the ad seller's interface, the ad media information including matching information; and
comparing the ad campaign matching information with the ad media matching information to determine whether the ad media is appropriate for an ad campaign.

14. The method of claim 13, further comprising:
associating an ad seller with the ad media information and alerting an associated ad seller if ad media is determined to be appropriate for an ad campaign.

15. The method of claim 14, further comprising:
accepting proposal input from an ad seller through the ad seller interface and providing the proposal input to the ad buyer associated with the ad campaign.

16. The method of claim 15, further comprising:
accepting response input from an ad buyer through the ad buyer interface and storing the response input.

17. The method of claim 16, further comprising:
establishing a communications channel between an ad buyer and an ad seller.

18. The method of claim 17, further comprising:
updating the ad campaign database to reflect communications between an ad buyer and an ad seller.

19. A system including a processor, comprising:
an ad campaign database manager;
an ad buyer interface to the ad campaign database manager; and
an ad seller interface to the ad campaign database manager.

20. The system of claim 19, wherein the ad buyer interface is configured to accept ad campaign information.

21. The system of claim 19, wherein the ad buyer interface is configured to accept ad campaign information that includes indicia of an ad campaign's targeted media type.

22. The system of claim 19, wherein the ad buyer interface is configured to accept ad campaign information that includes indicia of an ad campaign's targeted budget.

23. The system of claim 19, wherein the ad buyer interface is configured to accept ad campaign information that includes indicia of an ad campaign's calendar schedule.

24. The system of claim 19, wherein the ad buyer interface is configured to accept ad campaign information that includes indicia of an ad campaign's content.

25. The system of claim 19, wherein the ad buyer interface is configured to accept ad campaign information that includes matching information.

26. The system of claim 25, wherein the ad seller interface is configured to accept media information.

27. The system of claim 25, wherein the ad seller interface is configured to accept media information that includes a measure of media available for advertising.

28. The system of claim 25, wherein the ad seller interface is configured to accept media information that includes indicia of content type.

29. The system of claim 25, wherein the ad seller interface is configured to accept media information that includes matching information.

30. The system of claim 19, wherein:
the ad buyer's interface is configured to accept ad campaign matching information;
the ad seller's interface is configured to accept ad media matching information; and
the system is configured to compare the ad campaign matching information to the ad media matching information and to thereby determine whether ad media is appropriate for and ad campaign.

31. The system of claim 30, wherein the system is further configured to associate an ad seller with ad media information and to alert an associated ad seller if ad media is determined to be appropriate for an ad campaign.

32. The system of claim 30, wherein the system is further configured to accept proposal input from an ad seller through the ad seller's interface and to provide the proposal input to an ad buyer associated with an ad campaign for which the ad seller has been determined to be an appropriate match.

33. The system of claim 30, wherein the system is configured to accept response input from an ad buyer through the ad buyer interface and to store the response input.

34. The system of claim 30, wherein the system is configured to establish a communications channel between and ad buyer and an ad seller.

35. The system of claim 30, wherein the system is configured to update an ad campaign database to reflect communications between an ad buyer and an ad seller.

36. The system of claim 30, wherein the system is configured to update an ad campaign database in response to input from the ad buyer interface.
